(19) United States
(12) Patent Application Publication
(10) Pub. No.: US 2012/0148331 A1
(43) Pub. Date: Jun. 14, 2012

(54) Mechanical Carpenter's pencil

(75) Inventor: Daniel R. Seymour, (US)

(73) Assignee: Daniel R. Seymour, Middlefield, CT (US)

(21) Appl. No.: 12/966,915

(22) Filed: Dec. 13, 2010

(51) Int. Cl. B43K 21/22

(52) U.S. Cl. 401/92

(57) ABSTRACT

The instant invention is a mechanical pencil. The pencil consists of a body having a cavity and an engagement element. An engagement element is attached to the body and movable relative to the body from a first position to a second position, wherein when the engagement element is located at the first position the lead is able to move relative to the body and when the engagement element is located at the second position the lead is unable to move relative to the body.

### BACKGROUND OF INVENTION

1. Field of the Invention

The instant invention is a mechanical pencil.

Mechanical pencils are known more so for drafting. These pencils may be expensive and difficult to assemble.

Mechanical pencils compete with wood pencils and therefore need to be inexpensive with as few parts as possible.

### SUMMARY OF INVENTION

The instant invention is a mechanical pencil.

The pencil consists of a body having a cavity and an engagement element.

An engagement element is attached to the body and movable relative to the body from a first position to a second position, wherein when the engagement element is located at the first position the lead is able to move relative to the body and when the engagement element is located at the second position the lead is unable to move relative to the body.

### DESCRIPTION OF DRAWINGS

For the purpose of illustrating the invention, the drawings show the preferred; it being understood, however, that this invention is not limited to the precise arrangements and instrumentalities shown.

FIG. 1 An isometric view of the invention.

FIG. 2 An exploded isometric view of the invention.

FIG. 3 A side view of the invention.

FIG. 4 A cross sectional view of the invention with the engagement element in the first position.

FIG. 5 A cross sectional view of the invention with the engagement element in the second position.

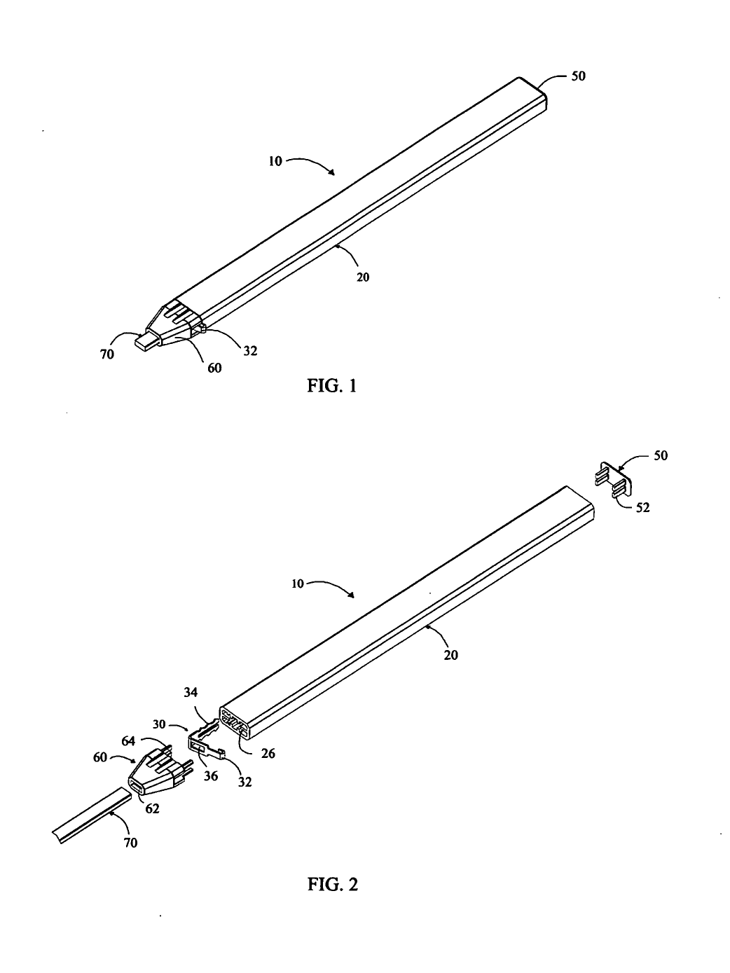

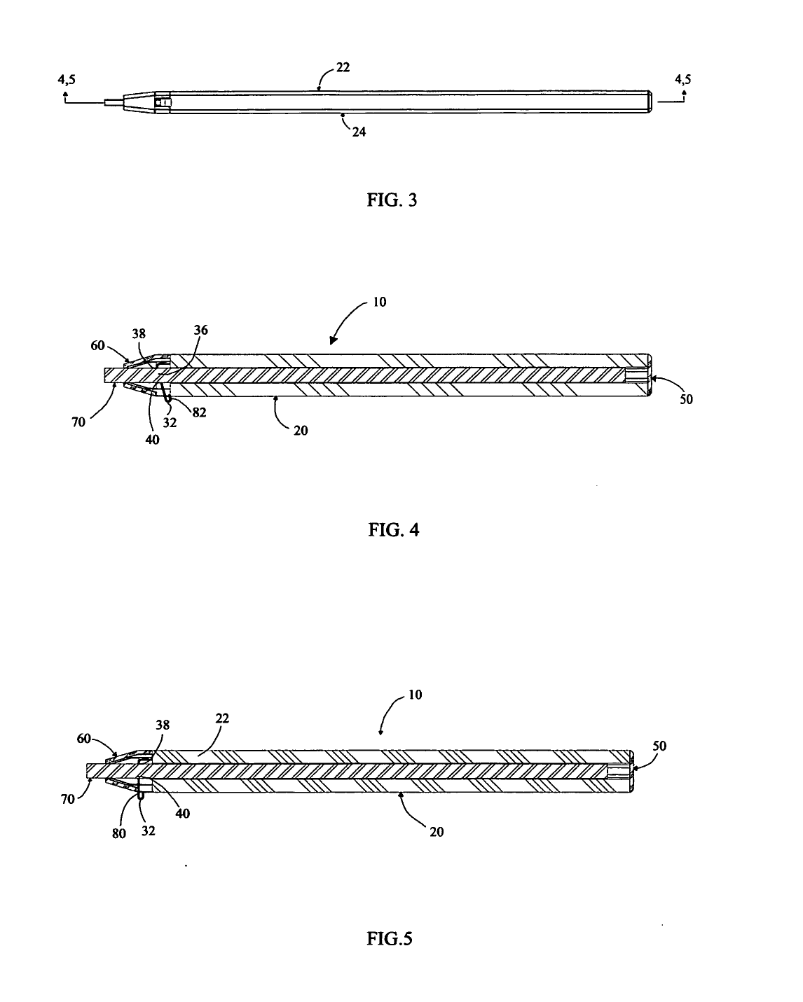

### DETAILED DESCRIPTION OF INVENTION

The mechanical pencil 10 shown in the drawings is particularly adapted for flat lead, such as in a carpenter's pencil. The mechanical pencil includes an elongated housing 20.

The elongated housing 20 includes a front wall 22 and a rear wall 24 of generally flat rectangular configuration. The elongated housing, 20, 22 and 24 define an elongated cavity 26. Attached to the housing is a tapered tip 60 having a pyramidal configuration which in turn defines a slot 62 at the front end thereof. The elongated body 12 and cavity 26 communicate with the slot 62, and a single piece of lead 70 of rectangular cross-section is adapted to slide in the elongated cavity along a lead path aligned with the slot 62. The preferred embodiment shows a cap 50 attached via one or more protrusions 52.

Engagement element 30 has one or more teeth 34 that anchor Engagement element 30 into cavity 26 of elongated body 20. Engagement element 30 contains slot 36 that is defined by edge 38 and 40. It is aligned with slot 62 to allow a piece of lead to slide a lead path in cavity 26. Engagement element has position 80 which allows a lead piece 70 to move freely along the lead path in cavity 26. Engagement element conversely has a second position 82 that arrests a piece of lead with edges 38 and 40.

What is claimed is:

1. A mechanical pencil comprising an elongated housing having a pair of opposed flat rectangular front and rear walls, the walls further defining an elongated chamber having flat parallel spaced-apart surfaces therein, the chamber including an elongated lead path spaced from the surfaces for accommodating a flat graphite lead member and extending axially of the elongated housing which communicates at one end of the housing with said opening in line with the lead path; an engagement element with a slot defined by two parallel edges that is attached to the body; the engagement element has two positions that provide a piece of lead to be free moving or arrested.

2. A mechanical pencil as defined in claim 1 that may include a pencil tip that has an integral slot and a cavity that allows a piece of lead to slide through it.

3. Mechanical pencil as defined in claim 1 that may have a cap that is secured to the body.
